(19) United States
(12) Patent Application Publication
(10) Pub. No.: US 2014/0316565 A1
(43) Pub. Date: Oct. 23, 2014

(54) NUMERICAL CONTROLLER

(71) Applicant: FANUC Corporation, Minamitsuru-gun (JP)

(72) Inventor: Kazunari AOYAMA, Minamitsuru-gun (JP)

(73) Assignee: FANUC Corporation, Minamitsuru-gun (JP)

(21) Appl. No.: 14/254,303

(22) Filed: Apr. 16, 2014

(30) Foreign Application Priority Data
Apr. 17, 2013 (JP) 2013-086947

(51) Int. Cl. B25J 9/16

(52) U.S. Cl. CPC B25J 9/16; Y10S 901/41
USPC 700/249; 901/41

(57) ABSTRACT

A numerical controller includes a numerical control unit for executing a numerical control program, a robot control unit for executing a robot program, a multicore processor having a plurality of cores, and a peripheral control LSI. The numerical control unit is assigned to one of the cores of the multicore processor and the robot control unit is assigned to one of the others. The multicore processor is connected to an internal bus of the numerical controller via the peripheral control LSI.

### BACKGROUND OF THE INVENTION

1. Field of the Invention

The present invention relates to a numerical controller for controlling working machines or industrial machines.

2. Description of the Related Art

As disclosed in Japanese Patent Application Laid-Open No. 4-155406 and Japanese Patent Application Laid-Open No. 10-83211, a numerical controller incorporating a robot controller therein is configured such that a numerical control unit and a robot control unit are connected with a motor control unit and a programmable machine control unit (PMC unit) via a bus. FIG. 2 illustrates an example of structure of such a conventional numerical controller.

As illustrated in FIG. 2, a numerical controller 10 includes a numerical control unit 11, a PMC unit 12, a motor control unit 13, an amplifier interface unit 14, and a robot control unit 91. The numerical control unit 11 is mounted with a processor 20, a DRAM 21 and a peripheral control LSI 22. The PMC unit 12 is mounted with a processor 30, a DRAM 31 and a peripheral control LSI 32. The robot control unit 91 is mounted with a processor 60, a DRAM 61 and a peripheral control LSI 62. The motor control unit 13 is mounted with a processor 40 and a peripheral control LSI 42.

The processors 20, 30, 40 and 60 perform processing for controlling the control units 11, 12, 13 and 91, respectively. The peripheral control LSIs 22, 32, 42 and 62 serve as bridges between an internal bus 15 for connecting the DRAMS 21, 31, 61 and the control units 11, 12, 13, 91 and the processors 20, 30, 40, 60. The amplifier interface unit 14 is mounted with a communication control LSI 50.

Further, a machine-side IO unit 16 is connected to the peripheral control LSI 32 in the PMC unit 12 via a field bus 17, and a motor drive amplifier 18 is connected to the communication control LSI in the amplifier interface unit 14 via a serial servo bus 19.

The processor 20 in the numerical control unit 11 is a main processor for the whole numerical controller 10, reads calculation results of the PMC unit 12, the motor control unit 13 and the robot control unit 91 via the internal bus 15 at each periodically generated interruption, and writes calculation results based on the read data into the PMC unit 12, the motor control unit 13 and the robot control unit 91 via the internal bus 15.

The numerical control unit 11 may read from and write into the control units (the DRAM 21 in the numerical control unit 11, the DRAM 31 in the PMC unit 12, and the DRAM 61 in the robot control unit 91), or the RAMs (not illustrated) incorporated in the peripheral control LSIs 22, 32, 42 and 62, respectively. The processors 20, 30, 40 and 60 in the respective control units are connected to the peripheral control LSIs 22, 32, 42 and 62 via an 8-bit to 64-bit bus, respectively. The peripheral control LSIs 22, 32, 42 and 62 serve as the bridges between the internal bus 15 and the processors 20, 30, 40, 60, and additionally serve as the processors or memories in the control units, respectively.

The processor 60 in the robot control unit 91 similarly exchanges data with each control unit via the internal bus 15.

The numerical controller 10 is mounted with the processor 20 in the numerical control unit 11 that calculates a command value for controlling the motor drive amplifier 18, and the processor 60 in the robot control unit 91 that creates a command value for controlling a robot and controlling the motor drive amplifier. The processors 20 and 60 are connected to the dedicated peripheral control LSIs 22 and 62 via 32-bit or 64-bit processor-only buses 23, 63, respectively.

Circuits usable for peripheral control LSIs increase along with an increase in semiconductor integration, and thus there is assumed as illustrated in FIG. 3 that peripheral control LSIs used in a plurality of functional blocks are integrated into an integrated peripheral control LSI 70, thereby reducing cost. However, a plurality of processors are connected to the integrated peripheral control LSI 70, and thus a large number of I/O pins are needed for the peripheral control LSI. There is a problem that when the number of I/O pins exceeds the number capable of being housed in a package assumed for the peripheral control LSI, the integration cannot be realized.

### SUMMARY OF THE INVENTION

It is therefore an object of the present invention to provide a numerical controller having a multicore processor in which a numerical control processor and a robot control processor, which are conventionally separate, are integrated into one processor, and to provide a numerical controller for connecting a processor and a peripheral control LSI via a fast serial bus thereby to reduce the number of LSI pins, and for enabling integration of peripheral control LSIs and reduction in cost.

According to a first aspect of the invention, a numerical controller including a numerical control unit for executing a numerical control program and a robot control unit for executing a robot program further includes: a multicore processor having a plurality of cores; and a peripheral control LSI. In addition, the numerical control unit is assigned to at least one of the cores of the multicore processor and the robot control unit is assigned to at least one of the other cores, and the multicore processor is connected to an internal bus of the numerical controller via the peripheral control LSI.

With the numerical controller, a multicore processor in which a numerical control processor and a robot control processor, which are conventionally separate, are integrated into one processor, is provided thereby to reduce the number of LSI pins, thereby enabling integration of the peripheral control LSIs and reduction in cost.

According to a second aspect of the invention, a numerical controller including a numerical control unit for executing a numerical control program and a robot control unit for executing a robot program further includes: a processor having a multithread function; and a peripheral control LSI. In addition, the numerical control unit is assigned to at least one of threads of the processor having the multithread function and the robot control unit is assigned to at least one of the other threads, and the processor having the multithread function is connected to an internal bus of the numerical controller via the peripheral control LSI.

The numerical controller uses a processor having a multithread function by which a plurality of threads can operate at the same time, thereby reducing the number of LSI pins and enabling integrations of the peripheral control LSIs and reduction in cost.

According to the present invention, it is possible to provide a numerical controller having a multicore processor in which a numerical control processor and a sequence control processor, which are conventionally separate, are integrated into one processor, and to provide a numerical controller for connecting a processor and a peripheral control LSI via a fast serial bus thereby to reduce the number of LSI pins, and for enabling integration of the peripheral control LSIs and reduction in cost.

### BRIEF DESCRIPTION OF THE DRAWINGS

The above and other objects and features of the present invention will be apparent from the following description of embodiments with reference to the accompanying drawings, in which:

FIG. 1 is a diagram for explaining an embodiment of the present invention using a multicore processor and an integrated peripheral control LSI;

FIG. 2 is a diagram for explaining a structure of a conventional numerical controller; and

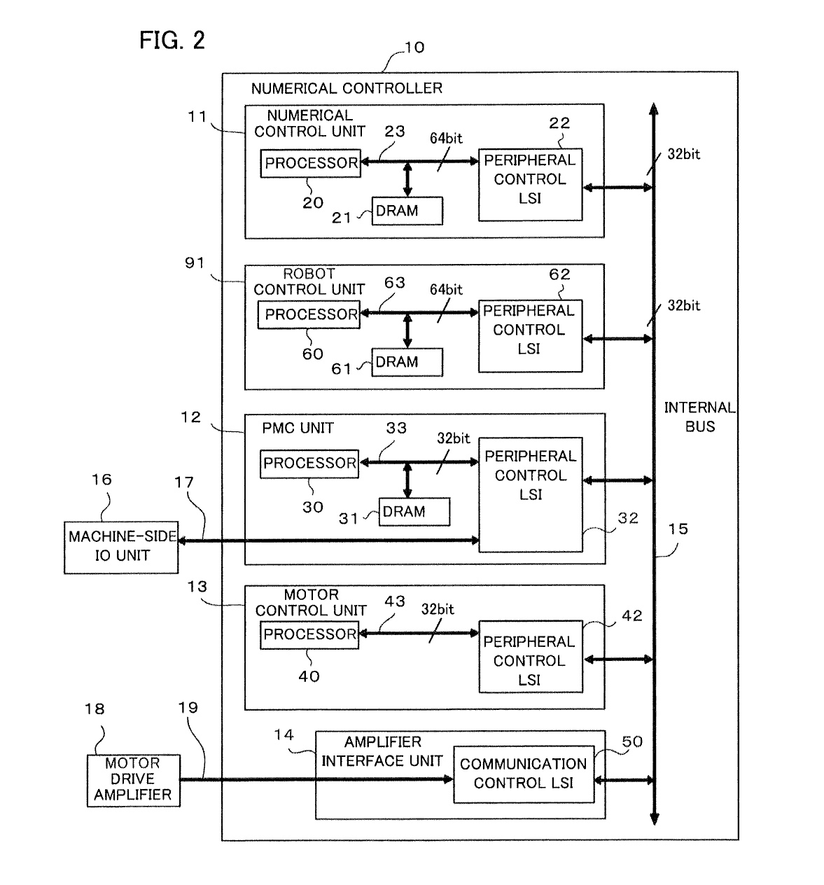

FIG. 3 is a diagram for explaining a problem of the present invention to be solved.

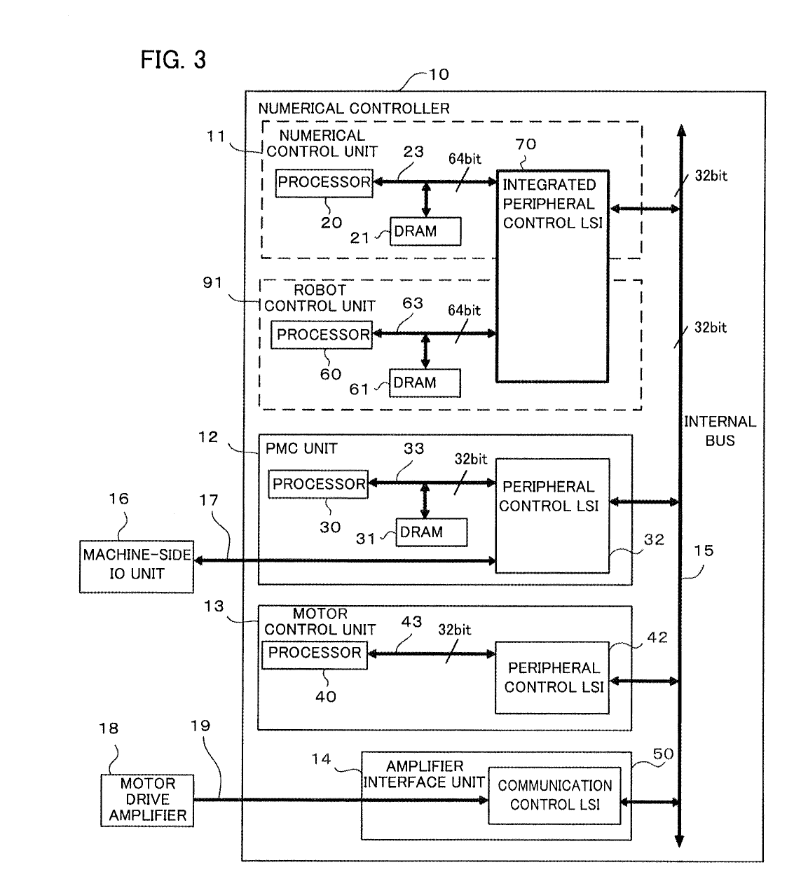

### DETAILED DESCRIPTION OF THE PREFERRED EMBODIMENTS

Recently, a multicore technique has been developed for processors to be connected to an integrated peripheral control LSI, and processing can be performed in a plurality of cores arranged in one processor. The present invention is directed for integrating peripheral control LSIs by applying the multicore processor technique to architecture of a numerical controller for controlling machine tools or industrial machines.

More specifically, according to the present invention, the respective functions for numerical control and robot control, which are conventionally performed in different processors, are assigned to and performed in the cores in the multicore processor, thereby integrating the peripheral control LSIs that have been required for the respective functional blocks.

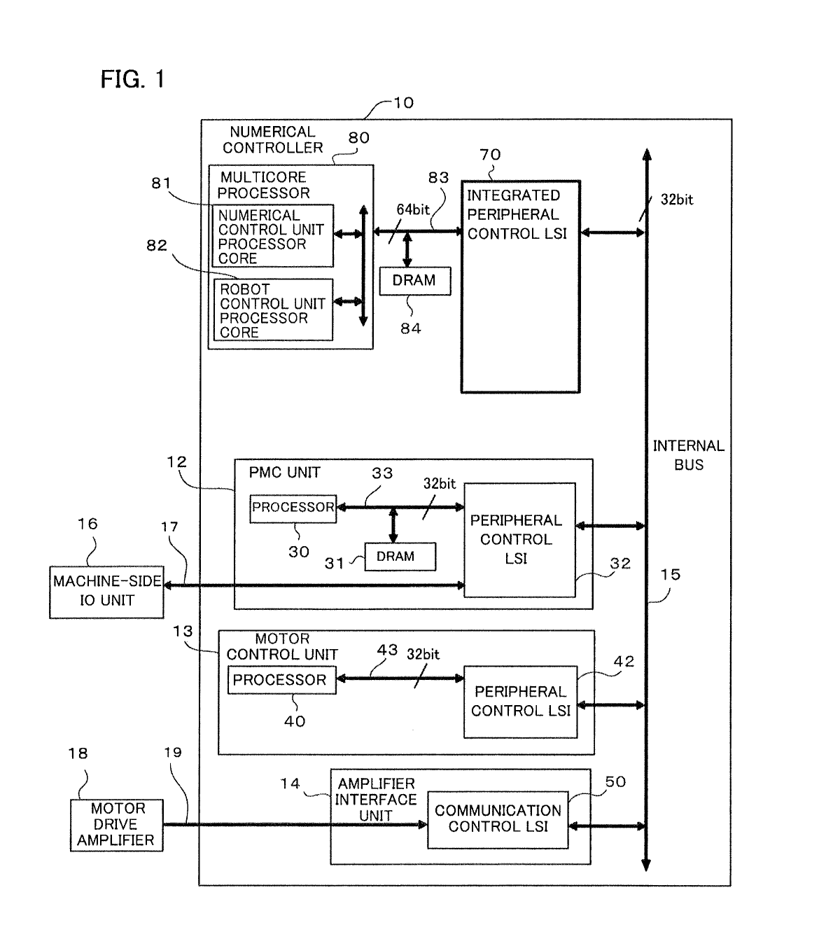

FIG. 1 is a diagram for explaining one embodiment of the present invention using a multicore processor and an integrated peripheral control LSI.

A numerical controller 10 is mounted with a multicore processor 80 and an integrated peripheral control LSI 70. The numerical controller 10 is provided with a PMC unit 12 having a sequence control processor 30 for controlling a DI/DO signal to the machine and its peripheral control LSI 32, a motor control unit 13 configured of a motor control processor 40 and its peripheral control LSI 42, and an amplifier interface unit 14 having a communication control LSI 50 for making communication with a motor drive amplifier 18, which are connected with each other via an internal bus 15.

The multicore processor 80 has two or more cores, where at least one of them is assigned as a numerical control unit processor core 81 and at least one of the rest is assigned as a robot control unit processor core 82.

The numerical control unit processor core 81 creates a command value for controlling the motor drive amplifier 18 connected to the numerical controller 10 via a serial servo bus 19 based on a numerical control program, and transmits the created command value to a RAM (not illustrated) inside the peripheral control LSI 42 in the motor control unit 13 via the integrated peripheral control LSI 70 and the internal bus 15.

The robot control unit processor core 82 also creates a command value for controlling the motor drive amplifier 18 connected to the numerical controller 10 via the serial servo bus 19, and transmits the created command value to a RAM inside the peripheral control LSI 42 in the motor control unit 13 via the integrated peripheral control LSI 70 and the internal bus 15.

The motor control processor 40 in the motor control unit 13 reads the command value written in the RAM (not illustrated) inside the peripheral control LSI 42 in the motor control unit 13, creates motor control data to be transmitted to the motor drive amplifier 18, and writes the created data in the communication control LSI 50 in the amplifier interface unit 14 via the internal bus 15.

The communication control LSI 50 in the amplifier interface unit 14 transmits the data written in the RAM (not illustrated) inside the communication control LSI to the motor drive amplifier 18 via the serial servo bus 19, and the motors (not illustrated) provided in the machine tool or the robot are driven by the motor drive amplifier 18.

The processor 30 in the PMC unit 12 executes a predetermined sequence control program based on input data from the machine tool (not illustrated) acquired via a field bus 17 connected to the numerical control unit processor core 81, the robot control unit processor core 82 and the machine-side 10 unit 16, notifies the numerical control unit processor core 81 and the robot control unit processor core 82 of the processing results, and transmits a signal for controlling each constituent of the machine based on the processing result to the machine-side IO unit 16 via the field bus 17.

The present embodiment is configured such that the numerical control unit is assigned to at least one of the cores of the multicore processor and the robot control unit is assigned to at least one of the other cores, but there may be configured such that a processor having a multithread function is employed instead of the multicore processor, at least one of the threads of the multithread processor is assigned to the numerical control unit and at least one of the rest is assigned to the robot control unit. Also in this case, the number of LSI pins can be reduced, and integration of the peripheral control LSIs and reduction in cost may be enabled.

There is assumed that when a plurality of cores are mounted on a processor and each core performs numerical control or robot control, traffics of the bus between the processor and the integrated peripheral control LSI is heavier than ever and performance of the numerical controller lowers. In this case, the multicore processor 80 may include a fast serial interface and may be connected with the integrated peripheral control LSI 70 via the fast serial bus, thereby keeping a traffic speed.

1. A numerical controller comprising a numerical control unit for executing a numerical control program and a robot control unit for executing a robot program, the numerical controller including:
a multicore processor having a plurality of cores; and
a peripheral control LSI,
wherein the numerical control unit is assigned to at least one of the cores of the multicore processor and the robot control unit is assigned to at least one of the other cores, and the multicore processor is connected to an internal bus of the numerical controller via the peripheral control LSI.

2. A numerical controller comprising a numerical control unit for executing a numerical control program and a robot control unit for executing a robot program, the numerical controller including:
a processor having a multithread function; and
a peripheral control LSI,
wherein the numerical control unit is assigned to at least one of threads of the processor having the multithread function and the robot control unit is assigned to at least one of the other threads, and
the processor having the multithread function is connected to an internal bus of the numerical controller via the peripheral control LSI.
